(19) United States
(12) Patent Application Publication
(10) Pub. No.: US 2016/0237933 A1
(43) Pub. Date: Aug. 18, 2016

(54) METHOD AND APPARATUS FOR CONTROLLING A RECIPROCATING-PISTON ENGINE HAVING SEVERAL CYLINDERS

(71) Applicant: Robert Bosch GmbH, Stuttgart (DE)

(72) Inventors: Martin Gustmann, Hochdorf (DE); Ruediger Fehrmann, Weinstadt (DE); Michael Heise, Stuttgart (DE); Anandhalingam Saravanalingam, Stuttgart (DE); Reimer Selle, Stuttgart (DE)

(21) Appl. No.: 15/044,624

(22) Filed: Feb. 16, 2016

(30) Foreign Application Priority Data
Feb. 18, 2015 (DE) 102015202949.2

(51) Int. Cl. F02D 41/14; F02D 41/26

(52) U.S. Cl. CPC F02D 41/1401; F02D 41/26

(57) ABSTRACT

A method for controlling a reciprocating-piston engine encompassing several cylinders, including generating a discrete-time signal by measuring a state variable of the reciprocating-piston sensor by way of a sensor and an associated evaluation circuit, superimposing onto the signal a summand signal obtained by time differentiation of the signal, or filtering the signal, in such a way that an amplitude of the signal is selectively made larger or smaller at useful frequencies of the signal, and further processing the superimposed signal by way of a user function related to at least one cylinder. A corresponding apparatus, a corresponding computer program, and a corresponding storage medium are also provided.

### CROSS REFERENCE

The present application claims the benefit under 35 U.S.C. §119 of German Patent Application No. 102015202949.2 filed on Feb. 18, 2015, which is expressly incorporated herein by reference in its entirety.

### FIELD

The present invention relates to a method for controlling a reciprocating-piston engine encompassing several cylinders. The present invention furthermore relates to a corresponding apparatus, to a corresponding computer program, and to a corresponding storage medium.

### BACKGROUND INFORMATION

For demanding drive systems with multi-cylinder internal combustion engines, individual-cylinder functions such as cylinder equalization and the observation of rotational nonuniformities constitute an important part of conventional engine controllers. For example, conventionally, for this purpose the amplitudes of significant signals such as rotation speed or relative oxygen content are evaluated at the camshaft frequency and multiples thereof.

German Patent Application No. 10 2005 057 975 A1, for example, relates to a method for individual-cylinder control of the fuel quantity and/or air quantity of an internal combustion engine, in which method a signal that is influenced by combustion or that relates to a variable that has an influence on combustion, and that contains successively time-offset information items from all cylinders, is evaluated by the fact that vibration components caused by individual-cylinder differences in the frequency range are ascertained and are regulated separately for selected frequencies, and an amplitude controller that determines the amplitude of a correction intervention, and a phase controller that determines the allocation of an intervention pattern with regard to the cylinders, are provided for each frequency to be compensated for.

European Patent No. 1178202 B1 furthermore describes a method for regulating an internal combustion engine, in which proceeding from at least one measured variable a control variable is predefined; the control variable is filtered with at least one filter; proceeding from the filtered measured variable, actual values and/or target values of the control system are ascertained; an excitation variable is superimposed on the control variable; and lastly, proceeding from the measured variable's reaction resulting therefrom, properties of the filtering means are determined.

### SUMMARY

The present invention provides a method for controlling a reciprocating-piston engine encompassing several cylinders; a corresponding apparatus; a corresponding computer program; and a corresponding storage medium.

One advantage of this approach is its suitability for compensating for the different transfer properties in terms of the principal feature of rotational nonuniformity, and for adapting useful amplitudes, without modifying the average values. It is thus possible to use different signal capture systems, having different transfer behaviors, in order to capture the signals that are the carriers of useful information for various functions. This allows the outlay for functional adaptation or re-parameterization to be reduced as compared with conventional approaches.

In one example embodiment, at least one application parameter can influence the proposed superimposition. Such a parameterization imparts a high degree of adaptability to the proposed method.

In addition, the superimposition can be preceded by a filtering of the measured signal. Any noise in the signal can in this manner be largely suppressed. Sliding averaging over three successive sampled values, or a PT2 transfer member, are possible in particular. A similar effect is achieved using order filters whose gain is adapted respectively for the useful frequencies.

In a preferred embodiment, the subsequently stored user function is the observation of a rotational nonuniformity at a crankshaft of the reciprocating-piston engine. In this case targeted countermeasures make it possible to decrease the threat of torsional oscillations in the downstream drive train, which might otherwise result in unpleasant engine noise. The use of additional two-mass flywheels or torsional vibration dampers can thus be avoided.

In the case of commercially usual internal combustion engines the combustion air ratio, as measured using a lambda probe with which the skilled artisan is familiar, is suitable as a state variable to be sampled. Combustion quality and optionally catalytic exhaust gas purification quality can thereby be optimized in targeted fashion in order to minimize the emission of pollutants such as nitrogen oxides, hydrocarbons, and particulates.

### BRIEF DESCRIPTION OF THE DRAWINGS

An exemplifying embodiment of the present invention is depicted in the figures and is described below in further detail.

FIG. 1 shows the data flow in the context of an example method according to a first embodiment of the present invention.

FIG. 2 shows the amplitude spectrum of a signal conditioned according to a second embodiment of the present invention.

FIG. 3 shows the amplitude spectrum of the signal conditioned according to the first embodiment.

### DETAILED DESCRIPTION OF EXAMPLE EMBODIMENTS

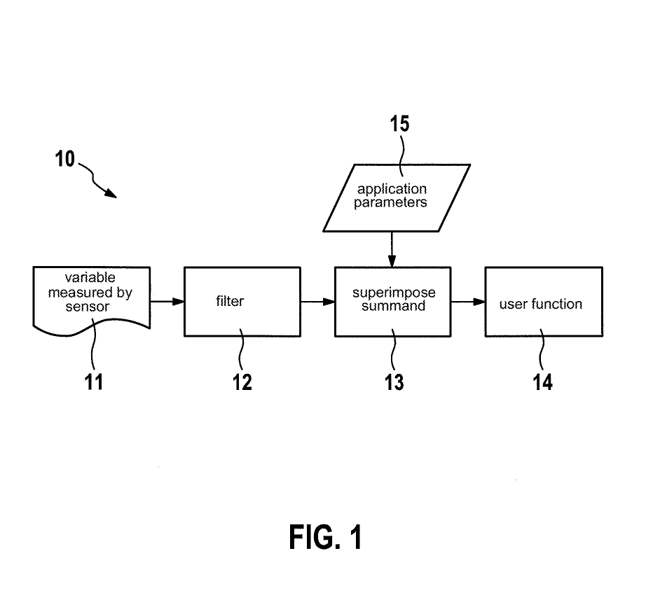

FIG. 1 illustrates, with reference to a data flow diagram, the schematically simplified manner of operation of a method 10 according to an example embodiment of the present invention. The starting point of method 10 is constituted here by a state variable, e.g., a combustion air ratio or rotation speed of a combustion engine, which variable is measured by way of a conventional sensor 11.

An engine controller receives measured values relevant thereto in the form of a time-varying signal that is converted by preferably periodic sampling, for example at a rate of 500 Hz, into a discrete-time signal.

The signal is then subjected to a filtering operation 12 before having a summand signal, obtained by time differentiation of the signal, superimposed upon it. Useful amplitudes are thereby increased under the influence of a wide variety of application parameters 15, along the lines of a “boost function.”

Lastly, a further processing of the superimposed signal by an individual-cylinder user function 14 occurs; a cylinder equalization or an observation of rotational nonuniformities by the engine controller is particularly appropriate.

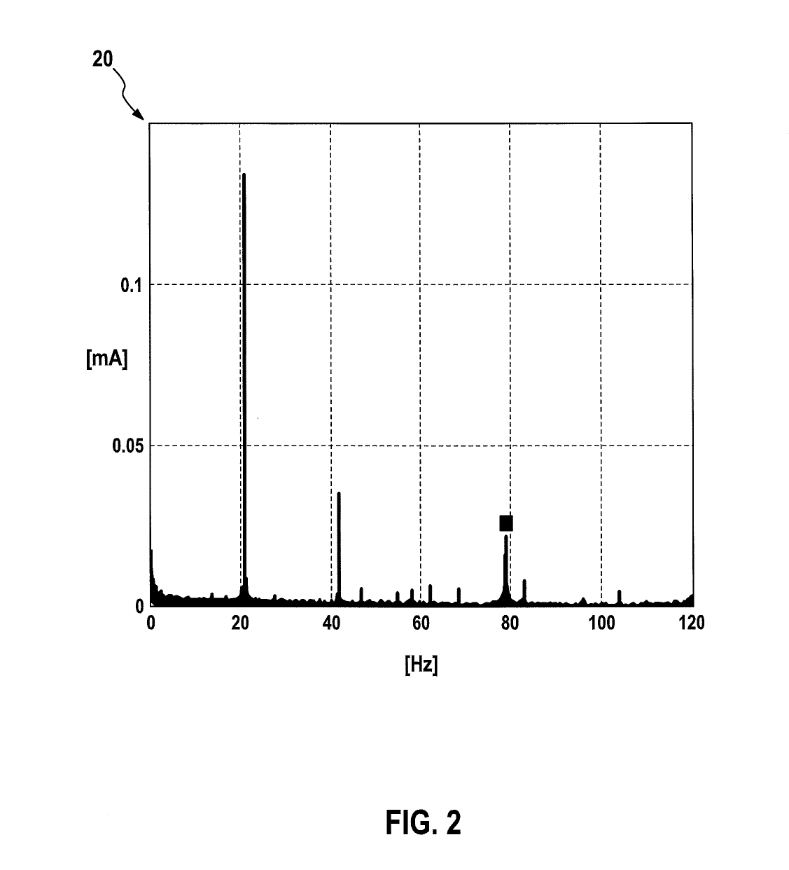

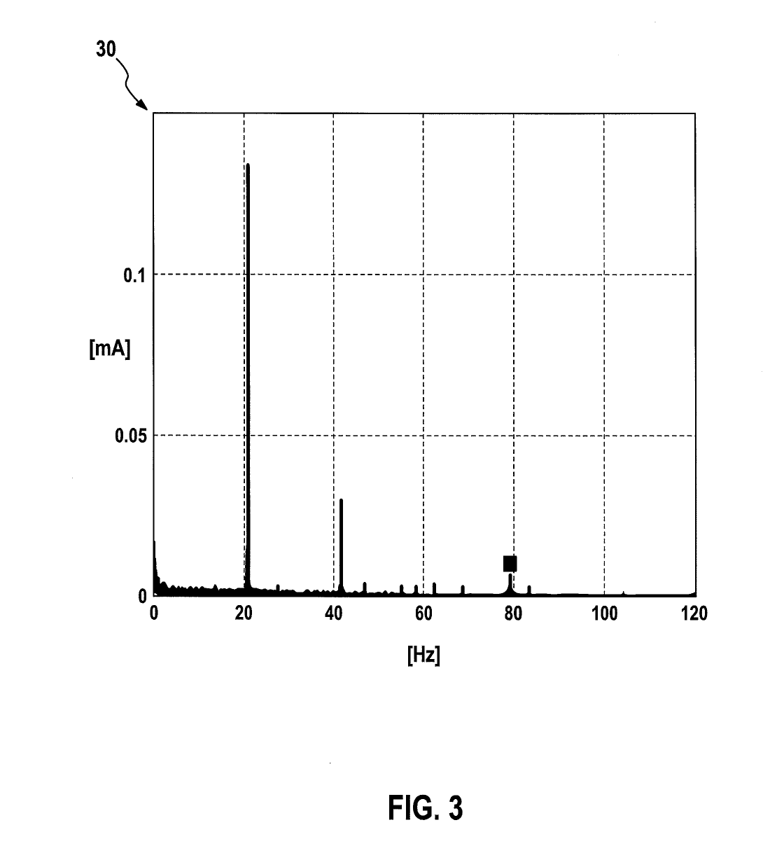

The effects of this approach will now be explained with reference to FIGS. 2 and 3, which reproduce amplitude spectra A(f) of the pump current Iₚ signal of an exemplifying multi-cylinder engine. The underlying signal is supplied here by a lambda probe thread-mounted in a cylinder bank, exhaust header, or exhaust manifold of the internal combustion engine, at an engine speed of 2500 min⁻¹ and a mass flow of 90 kg/h, and is carried by the pump current Iₚ—indicated, as illustrated, in “mA” units—of the probe.

In the optional embodiment of FIG. 2, a filtering 12 of the signal preceding the superimposition 13 is omitted. What results here at the useful frequency f_{NW}=20.8 Hz is a peak-to-peak amplitude A(f_{NW})=0.13309 mA, while the interference frequencies around f_{NW}=80 Hz are suppressed to A(79.25 Hz)=0.02547 mA.

The behavior is similar in the example according to FIG. 3. Here the amplitude increase is preceded by a filtering 12 of the signal via sliding averaging over three successive sampled values Iₚ, yielding a peak-to-peak amplitude A(f_{NW})−0.13212 mA at the useful frequency f_{NW}=20.8 Hz. The interference frequencies are suppressed here all the way to A(79.25 Hz)=0.01027 mA.

What is claimed is:

1. A method for controlling a reciprocating-piston engine having several cylinders, the method comprising:
generating a discrete-time signal by measuring a state variable of the reciprocating-piston sensor by way of a sensor and an associated evaluation circuit;
one of: i) superimposing onto the signal a summand signal obtained by time differentiation of the signal, or ii) filtering the signal, the superimposing or filtering being performed in such a way that an amplitude of the signal is selectively made larger or smaller at useful frequencies of the signal; and
after the superimposing or filtering, further processing the signal using a user function related to at least one cylinder.

2. The method as recited in claim 1, wherein at least one application parameter influences the superimposition.

3. The method as recited in claim 1, wherein the superimposition is preceded by a filtering of the signal.

4. The method as recited in claim 1, wherein prior to the superimposing, the signal passes through at least one of the following filters:
an averaging filter,
a PT2 transfer member, or
an order filter.

5. The method as recited in claim 1, wherein the user function encompasses an equalization of the cylinders.

6. The method as recited in claim 1, wherein the user function encompasses an observation of a rotational nonuniformity at a crankshaft of the reciprocating-piston engine.

7. The method as recited in claim 1, wherein the reciprocating-piston engine is an internal combustion engine, the sensor is a lambda probe, and the state variable is a combustion air ratio of the internal combustion engine.

8. An apparatus for controlling a reciprocating-piston engine having several cylinders, the apparatus comprising:
an engine controller configured to receive measured values of a state variable of the reciprocating-piston engine in the form of a time-varying signal, superimpose onto the signal a summand signal obtained by time differentiation of the signal, or filter the signal, the superimposing or filtering being such that an amplitude of the signal is selectively made larger or smaller at useful frequencies of the signal, and after the superimposing or filtering, execute a user function, related to at least one cylinder, that further processes the signal.

9. A machine-readable storage medium storing a computer program, the computer program when executed by a controller, causing the controller to perform the following:
generating a discrete-time signal by measuring a state variable of the reciprocating-piston sensor by way of a sensor and an associated evaluation circuit;
one of: i) superimposing onto the signal a summand signal obtained by time differentiation of the signal, or ii) filtering the signal, the superimposing or filtering being performed in such a way that an amplitude of the signal is selectively made larger or smaller at useful frequencies of the signal; and
after the superimposing or filtering, further processing the signal using a user function related to at least one cylinder.
